(19) United States
(12) Patent Application Publication
(10) Pub. No.: US 2007/0067237 A1
(43) Pub. Date: Mar. 22, 2007

(54) METHODS AND SYSTEMS FOR THE TRANSFER OF MONEY SERVICES PROVIDED TO NON-CITIZEN RESIDENTS

(75) Inventors: Michael L. Snow, Wayzata, MN (US); Peter H. Watson, Minneapolis, MN (US); Ronald G. Buck, Tonto Verde, AZ (US)

Correspondence Address: SCHWEGMAN, LUNDBERG, WOESSNER & KLUTH, P.A., P.O. BOX 2938, MINNEAPOLIS, MN, 55402, US

(73) Assignee: Groupo Dimex, LLC.

(21) Appl. No.: 11/530,281

(22) Filed: Sep. 8, 2006

Related U.S. Application Data
(63) Continuation of application No. PCT/US05/07731, filed on Mar. 9, 2005.
(60) Provisional application No. 60/551,533, filed on Mar. 9, 2004.

(30) Foreign Application Priority Data
Sep. 22, 2005 (US) 2005/088511

(51) Int. Cl. G06Q 40/00

(52) U.S. Cl. 705/39; 235/379

(57) ABSTRACT

A method of transferring monies from a non-citizen resident of one country to their family members residing in another country, including setting up an account at a local bank in which funds will be deposited and from which funds will be transferred from, requesting an EFT from the bank to a non-banking institution in another country, providing for the recipient to present a cash equivalent device, adding the transferred monies to the recipient's cash equivalent device, and providing a call center where parties to the transaction may report issues and have issues resolved by personnel fluent in the native language of the parties.

### PRIORITY INFORMATION

This application is a continuation under 35 U.S.C. 111(a) of PCT/US/2005/007731, filed on Mar. 9, 2005, and published in English on Sep. 22, 2005 as WO 2005/088511, which claims the benefit under 35 U.S.C. 119(e) of U.S. Provisional Application Ser. No. 60/551,533, filed Mar. 9, 2004, which applications and publication are incorporated herein by reference.

### TECHNICAL FIELD OF THE INVENTION

The present invention relates generally to the transfer of monies over international borders, and more particularly to the transfer of monies from non-citizen residents to their family members in their country of origins, where the recipient does not make use of a banking institution.

### BACKGROUND

Many countries, such as the United States, have a large immigrant population. In the hopes of greater opportunities, these immigrants search for countries where those opportunities are plentiful. However, they never forget the family members remaining in their countries of origin. The immigrants send as much of their earnings and other income back home as they can. These families come to rely on this money to survive and prosper.

This system of sending money back home is becoming a large part of the revenue stream for many countries, especially those in Latin America, where money sent back home is beginning to overtake tourist revenues as the largest source of money entering those countries.

In the past transferring money over international borders was cumbersome and costly. It was restricted to those peoples who had experience and knowledge of the system. Those systems were typically wire-transfer methods from one bank to another. A user wishing to transfer monies into a foreign country were required to have a prior existing relationship with a large bank, monies in an account at the bank, and that the intended recipient also have a relationship at a bank in their country as well. Monies were transferred using these wire-transfer services from the source bank to the destination bank, and then the recipient was able to withdraw funds based on those transferred monies. These services were and are typically used by business people and large fees are typically charged for them. However, this represents a large barrier of entry to a small individual who may or may not have an account at that bank, or any bank, for that matter. These small individuals are thereby forced to other methods to send money back home to their relations.

There are millions of non-citizen residents in this country that seek to send money back home. As stated above, they are typically unable or unwilling to use traditional banking services. In addition, there is typically a language barrier as these large banks may or may not have customer service personnel skilled in communicating to this community of potential customers. These millions of non-citizen residents need to send millions of dollars back home, representing a large opportunity to those merchants that can provide a service to them.

Because of the large opportunity here, many money transfer concerns have been started. Though they may get a majority of their money back home, the immigrants are faced with large hidden fees from these concerns. Immigrants use these money transfer concerns because of a systemic distrust of the banking system. In their countries of origin, their national currencies may have undergone multiple devaluations and even if they had money in the bank in the past, these devaluations have effectively reduced their savings to nothing. This distrust of the banking institutions leads to situations where people are more likely to store their savings personally, and never utilize the banks, creating what some term a ‘mattress economy.’

This distrust of banking in general does typically follow the immigrant to their new country. Immigrants are very reluctant and very slow to adopt banking habits, and therefore their integration into society becomes hampered. And more specifically, their utilization of banking services is curtailed.

What is needed is a way to easily and safely transfer money from an immigrant to their family back home that does not involve typical banking institutions in the recipient's country, and also allows for the integration of the immigrant into the banking community in the country where they presently reside.

### SUMMARY

According to an embodiment, the present invention provides a method for a non-citizen resident of the United States to transfer monies to a recipient outside of the U.S. without the use of typical banking institutions. According to another embodiment, the present invention provides a method of providing a money transfer service to non-citizen residents, enabling the non-citizen resident effects a monetary contribution to a cash equivalent device in the possession of the intended recipient of the contribution. According to another embodiment, the present invention provides a method for a non-citizen resident to send money to family members in a foreign country, where the family members do not need to access typical banking institutions. According to another embodiment, the present invention provides a method of providing Electronic Fund Transfer (EFT) services to small banks in areas populated by large immigrant, or non-citizen resident, populations. According to another embodiment, the present invention provides a method of integrating a non-citizen resident into the banking user community.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is an exemplary schematic illustration demonstrating a representative transaction according to an embodiment of the present invention.

FIG. 2 is a flowchart illustrating generally, among other things, an example method of setting up a banking account according to an embodiment of the present invention.

FIG. 3 is a flowchart illustrating generally, among other things, an example method of transferring money according to an embodiment of the present invention.

FIG. 4 is an exemplary schematic illustration showing parties to a money transfer transaction according to an embodiment of the present invention.

FIG. 5 is an example of data structures according to an embodiment of the present invention.

FIG. 6 is an example functional diagram of a system according to an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

Reference is made in the present application to a non-citizen resident. What is meant by such a term is that person who resides in a country but has not yet become a full citizen of that country. Further, that person may be in a country legally or illegally. Further, though the term non-citizen resident is used, it is used a simple descriptor for an immigrant to any country. As the immigrant, or non-citizen resident, becomes more integrated and comfortable in that country, they may seek to become full citizens. According to the teachings of the present invention, citizenship does not remove a transaction from its scope, as a citizen who has family in another country may also wish to send money back home. As such, though the term non-citizen resident is used, a citizen may be within the scope of the present teachings.

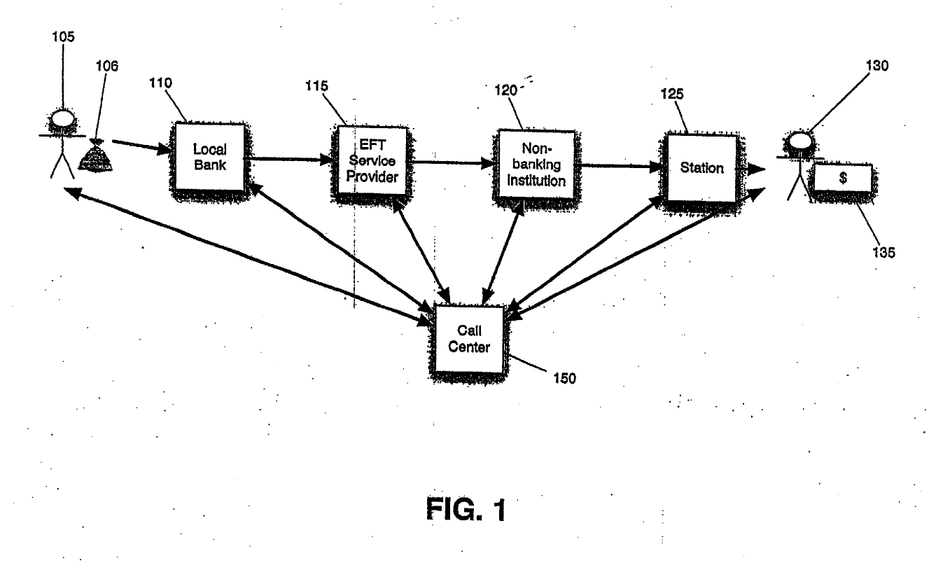

In FIG. 1, an exemplary illustration of a typical transfer of monies as contemplated by the present invention is given. A non-citizen resident user 105 has an amount of money 106 to deposit into their bank 110. In the example of FIG. 1, this non-citizen resident 105 has previously set-up their account, described in more detail below, and this account has pre-defined transfer policies associated with it. The non-citizen resident's bank 110 will deposit the monies 106 into the previously set-up account of the non-citizen resident 105. According to the transfer policies instantiated at the time of the account set-up or a subsequent change to the policies, a percentage of the monies 106 are deposited directly into the account. A further percentage of the monies 106, are designated to be transferred to some recipient 130, who is located in some foreign country. The bank 110 utilizes the services of an EFT service 115 to affect the transfer of those funds to an institution 120 in the country of the recipient 130. In an embodiment, the institution being transferred money to is a non-banking institution. According to the teachings of the present invention, a banking institution is a corporate body whose primary business is the handling of money, in that they provide depository services, typical banking services such as interest bearing accounts, loan services, and the like. According to the teachings of the present invention, a non-banking institution is a corporate body whose primary business is not the handling of money, but may as part of their overall business handle the receipt of funds and the disbursement of funds to its customers. An example of this type of institution is a telephone company. Further non-banking institutions are also contemplated under the present invention, though not specifically listed.

The non-banking institution 120 will receive the transferred monies and make those monies available to the intended recipient. In an embodiment, the recipient 130 has a cash equivalent device 135 onto which these monies may be deposited. In an embodiment, the recipient while utilizing some station 125, can add these monies to the cash equivalent device, thereby increasing the amount of monies available on the cash equivalent device. This cash equivalent device may take the form of such things as a stored-value card, a smart card, a debit-type credit card, or any such device that carries with it some monetary value which the user may utilize at a merchant or a provider of services, to include redeeming some amount on the device for an equivalent amount of cash in the currency of the country. These examples are not to be taken in a limiting sense, as any number of devices may be able to securely store information as to cash equivalency. Further, the device itself may not store information directly, but such information may be stored remotely and when using the device, a user may access such information, effect a transaction for some amount of money, and such money will be deducted from that user's account being remotely stored. In such a case it would be advantageous for that user to authenticate themselves in some manner such as by the use of a Private Identification Number (PIN).

According to the exemplary illustration of FIG. 1, the recipient 130 presents the cash equivalent device 135 to the station 125 for the purposes of adding some monetary amount to the device 135. This station 125 is some location accessible to the recipient and may include, but not be limited to, traditional Automated Transfer Machines (ATM), telephones, merchant stores, as well as traditional banks. After presenting the device 135, a monetary amount is added to the value of the device 135. The act of presenting may include, but not be limited to, inserting such device into an apparatus such as a card-reader, presenting the device to a teller at a bank, presenting the device to a staff person at a location of the non-banking institution, or presenting the device to personnel staffing a merchant store which accepts the presentation of such devices for the purposes of adding value to them. The recipient may now take the device 135 and use it to purchase items from vendors who accept such devices 135.

Recognizing that the use of such a system may sometimes be difficult, a call center can 150 be utilized. This call center 150 is staffed with personnel who understand the entire transfer system and the methods utilized therein. These personnel are skilled in communications with the languages of all users of this system. For example, the EFT Service Provider may be located in a country where the language spoken is English, the bank may be located in a country where the language spoken is English, the non-banking institution may be located in a country where the language spoken is Spanish, and the recipient may only speak Spanish. In such a case, the call center should be fluent in both English and Spanish. This example is not to be taken in a limiting sense, as this system may span many countries, and many languages. In an embodiment, the call center is staffed with personnel fluent in all the languages of all the countries in which some part of the present invention is carried out in. Further, it is to be understood that the call center 150 itself may be located in any number of countries. In an embodiment, the call center is located in the country where the EFT Service Provider 115 itself is located, or the country where the recipient 130 is located, or the country where the non-citizen resident 105 is located. In an embodiment, the call center 150 may be located in a country where none of these entities are located. In an embodiment, the call center 150 personnel should be trained to respond to issues that may present themselves during a transfer of funds from a non-citizen resident 105 to the cash equivalent device 135 held by the recipient 130. These issues may include difficulties in using a station 125 to add monies to the device 135, methods of depositing monies into the source bank 110 by the non-citizen resident 105, and assistance to the source bank 110. The call center may also be equipped to respond to questions from customer service representatives that are employed by the source bank 110 to facilitate this entire process for the non-citizen resident 105.

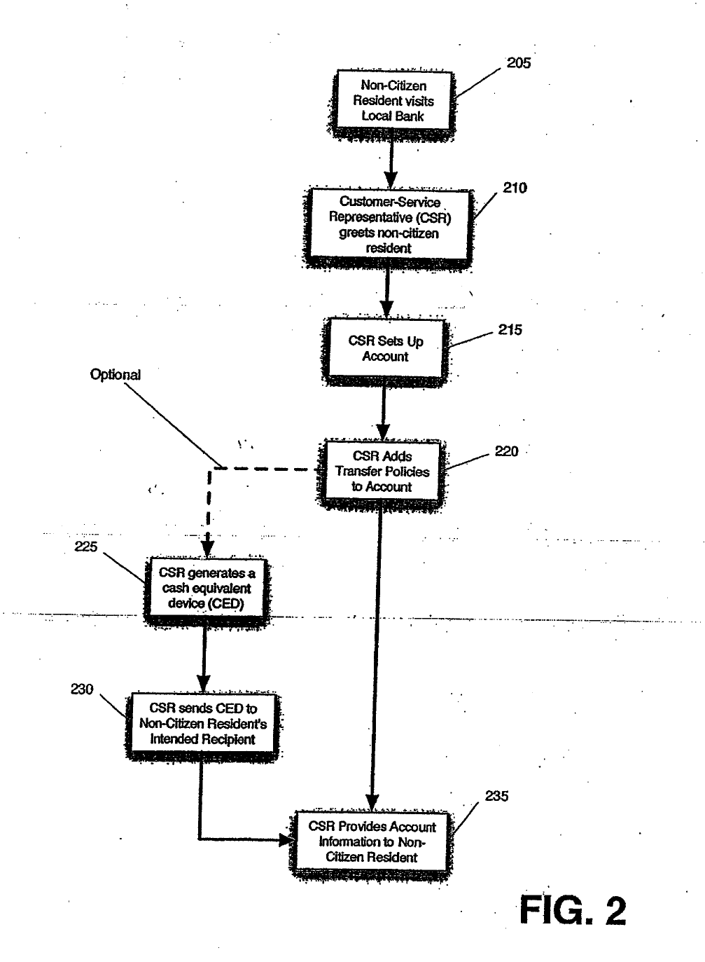

FIG. 2 represents an example method according to an embodiment of the present invention where a non-citizen resident, such as the non-citizen resident 105 of FIG. 1, to initially set-up an account from which funds can be transferred to other countries, such as their country of origin, and to their family members there. The non-citizen resident presents themselves at the bank at 205. The non-citizen resident will have been made aware of this money transfer service through the use of advertising and marketing directed to similar non-citizen residents, such as Mexican-Americans. A Customer Service Representative (CSR) will be available in the bank for the non-citizen resident to interact with. In an embodiment, the CSR is fluent in the native language of the non-citizen resident and that this CSR be trained in account set-up as well as general knowledge of the entire process. This provides to the non-citizen resident a friendly and understanding person to interact with at the bank and through whom they can begin to build a relationship with the bank. This relationship with the bank can then be leveraged in the future to enable the non-citizen resident to make use of the other services the bank may have to offer and to provide a level of trust in banking, in general, to the non-citizen resident. The CSR will then set-up an initial account for the non-citizen resident. This account may include, but not be limited to, a checking account 216, savings account 217, or an interest-bearing account of some manner 218. The CSR can then inquire as to the needs of the non-citizen resident for sending money back home at 220. This may include, but not be limited to, the names of intended recipients of funds, their addresses, percentage of their deposits they wish to send home, actual dollar amounts to send home and the periodicity of such transfers. In an example, the non-citizen resident may wish to allocate a percentage of every deposit for their mother, such as 25%. In such an example, when the non-citizen resident deposits $100 in their account, $25 would then be transferred. In an example, a transaction fee is deducted from the $25 and an amount less then $25 is made available to the recipient. In an example, the full amount of $25 is made available and a transaction fee is deducted from the account of the non-citizen resident. In an example a transaction fee is deducted both from the amount to be transferred and the source account. In an example, no transaction fee is deducted. In an embodiment, a conversion from the currency of the non-citizen resident, such as U.S. dollars, to the currency of the recipient, such as Mexican pesos, is made.

In the example of FIG. 2, there may be multiple transfers set up. For example, the non-citizen resident may with to transfer 25% of every deposit to their mother, and also transfer an additional 15% of every deposit to their sister, or other relation. Further, the transfer policy may not be a percentage of deposit, but may be a fixed amount to be transferred periodically to an intended recipient. For example, the non-citizen resident may wish to have $100 sent to their mother back home every month on the 1^{st} of that month. In an example, a transaction fee is deducted from the amount to be transferred. In an example, a transaction fee is deducted from the source account. In an example a transaction fee is deducted both from the amount to be transferred and the source account. In an example, a transaction fee is not deducted.

At 225, the CSR generates a cash equivalent device for the use of the intended recipient. This cash equivalent device denotes any device or card that can either carry or access a monetary amount, such as, but not limited to, stored value cards, smart cards, credit cards, or the like. It is to be understood that this also includes devices that do not store monetary information on the device itself, but access such information from a remote location. In an example, the cash equivalent device is produced at the location of the CSR and given to the non-citizen resident, and the non-citizen resident may send the device via postal or other delivery means to the intended recipient. In an example, the CSR may arrange for delivery of the device to the intended recipient. In an example, the device is produced at a separate location and sent directly to the intended recipient. In an example, the device is produced by the non-banking institution, such as contemplated in FIG. 1 at 120. At 235, the CSR will provide information and a summary of the arrangements for the transfer to the non-citizen resident. In an example, at 235, the CSR may also explain to the non-citizen resident some of the other services the bank may offer to the non-citizen resident. In an example, the CSR may arrange for the direct deposit of the non-citizen resident's periodic paycheck to their account. In an example, the CSR will provide a friendly, single point of contact for the non-citizen resident, so that the non-citizen resident may feel comfortable with the bank and choose to utilize the bank's other services.

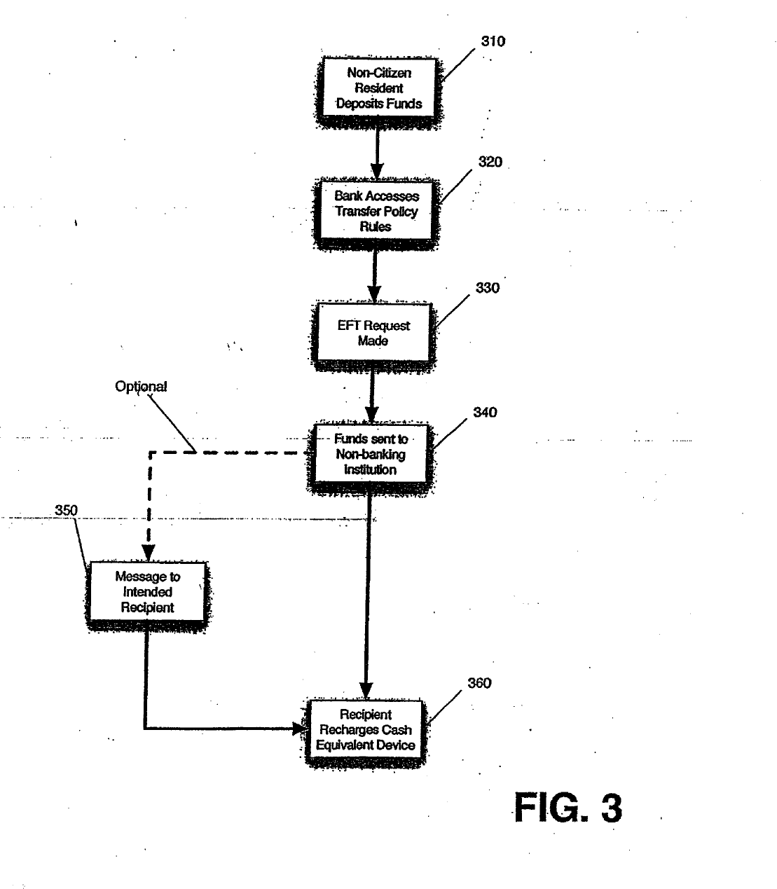

FIG. 3 depicts a flowchart, showing an example of a method according to the teachings of the present invention in which a non-citizen resident effects a transfer of monies to a recipient in another country, whereby the recipient's receipt of such monies does not involve a banking institution. At 310, the non-citizen resident deposits some amount of monies in their account at their bank. FIG. 2, above, depicted an example method of setting up such an account. In an example, this deposit is a direct deposit from the non-citizen resident's employer. In an example, this deposit is a cash deposit made at an Automated Transfer Machine (ATM). In an example, this is a check deposit made at a teller at the non-citizen resident's. It is to be appreciated that these methods are typical deposit methods, though other methods may be used to deposit funds into an account, and are considered to be within the scope of the present invention. It is advantageous if the deposit of monies into an account which is set up for subsequent transfer of monies home is no different than any other deposit that the non-citizen resident makes. It will be recognized that special forms for deposit and subsequent transfer create a likelihood of confusion for the non-citizen resident. Such confusion would lead to dissatisfaction with the banking system and further alienate such non-resident citizen from the further use of the banks in general. This in turn prevents the non-citizen resident from being integrated into the banking community and never taking advantage of the many services that banks have to offer.

As the account that the non-citizen resident has set up has special transfer policies associated with it, a deposit of funds into the account may invoke such policies. At 320 the policies are accessed and acted upon. As described above, such a policy may represent a percentage of monies deposited being directed to a recipient in another country. In such an example, that percentage of monies would be sent via Electronic Funds Transfer (EFT) means to a non-banking institution where the intended recipient can access those funds via any number of methods, further described below. Such a policy may be a periodic transfer of funds from the account to the intended recipient, such as a monthly transfer of some pre-determined amount of monies. In such an example, this monthly, or other periodic, transfer would be send via EFT means to a non-banking institution where the intended recipient can access those funds via any number of methods, further described below. At 330 the EFT request is communicated over some network and at 340 it is received by the non-banking institution. In an example, this non-banking institution may be a phone company. In an example, at 350, a message is sent to the intended recipient that some funds are available to them. In an example this message will not state the exact amount of funds available. In an example, no such message is generated, and as such, the step at 350 would not be needed. At 360 the intended recipient would add those funds to their cash equivalent device. In an example, this would take the form of recharging their stored value card with the monies transferred via EFT. In an example, the intended recipient recharges their stored value card at a telephone, which has a card reader attached. In such an example, the intended recipient would place the stored value card in the reader, which would authenticate such card, and communicate to the non-banking institution over some network, the non-banking institution communicating back to the card reader that an amount is to be added to the card, and the card reader adding such value to the stored value card. In an example, the recipient may present the device at some staffed location of the non-banking institution where staff at the location would be able to affect the adding of value to the card. Though the term card is used, it is to be understood that this device may take any shape or form, and card is merely being used for descriptive purposes. It is to be understood by those skilled in the art, that several non-card based cash equivalent devices exist presently, and that such non-card based devices are contemplated and within the scope of the present invention.

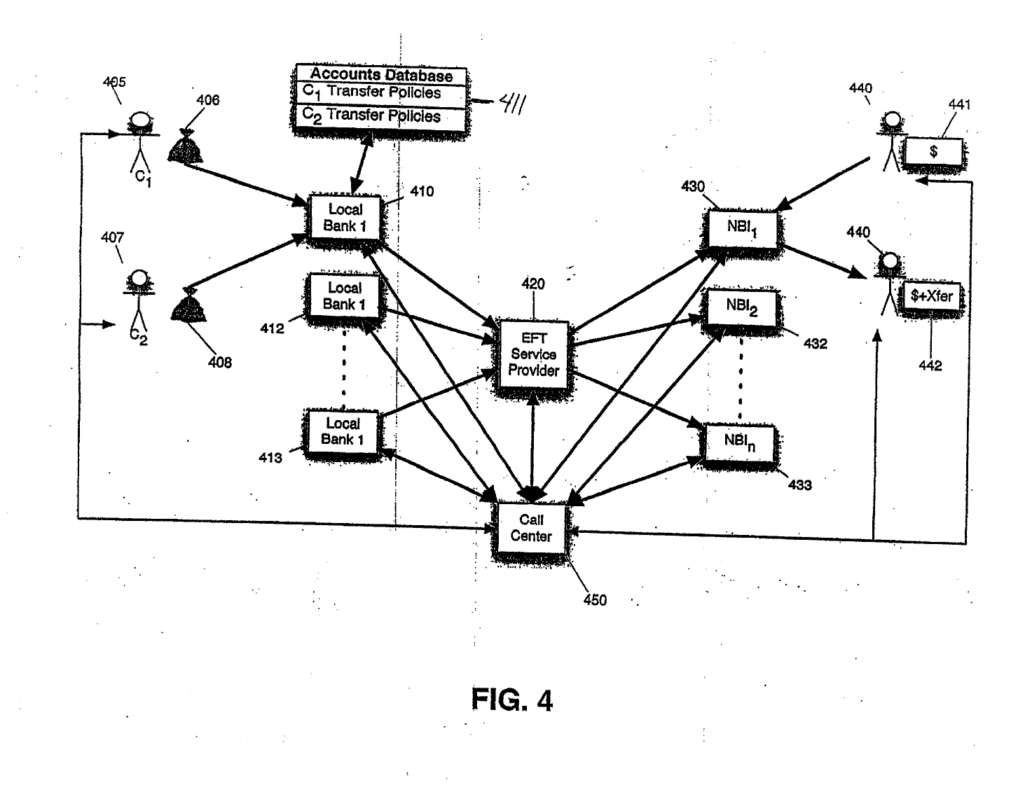

FIG. 4 presents an exemplary schematic illustration of an overall system of money transfer services for non-citizen residents to send money to their country of origin. Non-citizen resident 405 would deposit monies 406 into an account at their bank 410. This account would have been previously set-up, such as according to the example provided in FIG. 2 and its accompanying description. Though reference is made to the account being set-up prior to the actual deposit, it should be recognized that the non-citizen resident may affect such set-up at the time of the first deposit of funds. Further, this may be advantageous as the non-citizen resident has a present need to transfer funds and the bank is providing that service to them at that time. In an embodiment, the bank is able to set up the system contemplated by the present invention at a time substantially concurrent with the non-citizen resident's first visit to the bank. The bank, upon depositing said monies, 406, 408 would access the pre-defined policies 411 governing transfer of funds and initiate an EFT request for those amounts to an EFT service 420. Such a service 420 would then further communicate that request to the non-banking institution 430. The non-banking institution would then make available those funds for the intended recipient 440. In an example, the intended recipient would be made aware of available funds through a message from the non-banking institution. In an example, the non-banking institution would not send a message regarding available funds to the recipient. The intended recipient 440 would then carry their cash equivalent device 441 to a station where they could add the transferred funds to their cash equivalent device 441. In an example, this station is a telephone, with a card reader. In an example, this station is at a location of the non-banking institution where the recipient 440 could present the card to a staff member. In such an example, the staff member would be able to affect the addition of funds to the cash equivalent device. The intended recipient 440 would then be presented with their cash equivalent device 442, such that the device depicted by 442 has some amount of monies on it that were not present in its prior state as depicted by 441.

In FIG. 4, a call center 450 is depicted. This call center is meant to provide support for the process of transferring money according to the present teachings. This call center 450 would provide support to all persons and institutions involved in such a transfer. In an example, this call center 450 is located in the same country as the intended recipient 440. In an example, this call center 450 is located in the same country as the non-citizen resident 405. In an example, this call center 450 is located in some country other then the country where the intended recipient 440 or the non-citizen resident 405 are located. It is advantageous that this call center 450 be staffed with personnel fluent in the native languages of the non-citizen resident 405 and the intended recipient 440, as well as the languages of the bank 410. Such as, if the intended recipient 440 was in Mexico and the non-citizen resident 405 had migrated from Mexico to the United States. In such a situation, it would be advantageous if the call center personnel were fluent in both English and Spanish. In an example, the call center 450 personnel are fluent in all native language of all parties in this process, such as the non-citizen resident 405, the bank 410, the EFT service provider 420, the non-banking institution 430 and the intended recipient 440. The call center 450 responds to issues, problems, or questions from the system's user. Such as, if the intended recipient 440 did not know locations where they could add the transferred funds to their device 441. In such an example, the call center 450 personnel would locate the intended recipient and provide them directions to the closest, accessible locations for them to add value to their device 441.

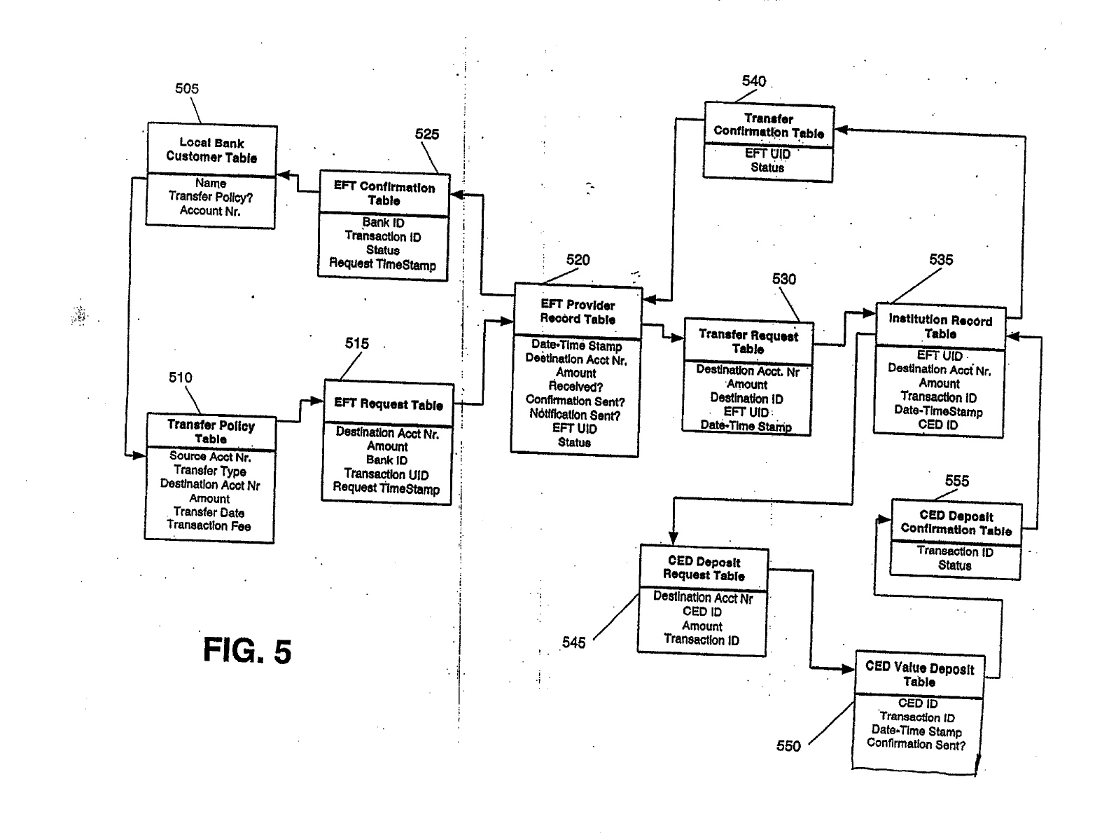

FIG. 5 is an example of data structures according to an embodiment of the present invention. The Local Bank Customer Table 505 maintains information about each individual customer including those customers who take advantage of the transfer mechanisms as contemplated by the present invention. The Transfer Policy Table 510 maintains information as to the transfer choices that the non-citizen resident has made. One example of a choice is whether the non-citizen resident wants a percentage of each deposit transferred to their intended recipient. Another example is the date of a regular periodic transfer, such as $50 every month on the 1^{st} of the month. The Transfer Policy Table 510 also maintains information as to the charging or not charging of a transaction fee. When a transfer of finds from a non-citizen resident to their intended recipient is initiated an EFT request is made, with information such as that contained in the EFT Request Table 515. The EFT Provider maintains a transaction table, such as that depicted by the EFT Provider Record Table 520. Once an EFT Request is received a record is added to the EFT Provider Record Table 520 and an EFT Confirmation is sent to the initiating bank. Information such as the example of the EFT Confirmation Table 525 is provided to the initiating bank, so that the bank can update its records. The EFT Provider in turn initiates a transfer of funds to the non-banking institution. The Transfer Request Table 530 provides an example of information that might be contained in such a request. The EFT Unique Identifier (UID) allows the EFT Provider to receive a confirmatory message as to a specific transfer. The non-banking institution receives the request and updates its Institution Record Table 535. In turn it sends a confirmatory message back to the EFT Provider containing information such as that included in the Transfer Confirmation Table 540. The non-banking institution can then initiate its process to add value to the cash equivalent device (CED) of the recipient. Upon presentation of such a device, the recipient will have the amount transferred added to their device. In an embodiment, the amount transferred may be reduced by a nominal handling fee. During presentation for the purpose of adding value a CED Deposit Request is initiated, containing information such as that contained in the CED Deposit Request Table 545. Included with that information is a Transaction ID, which is used by the non-banking institution to track the status of all pending transfers of monies to CED's of all customers. Following the adding of value to the CED, a confirmatory message will be sent to the non-banking institution as to the status of the CED and the transfer. It is to be understood that FIG. 5 and the accompanying description is merely one example of data structures meant to carry out the teachings of the present invention. Other data structures may be used to carry out the invention and it is manifestly intended that the present invention be limited only by the appended claims and equivalents thereof.

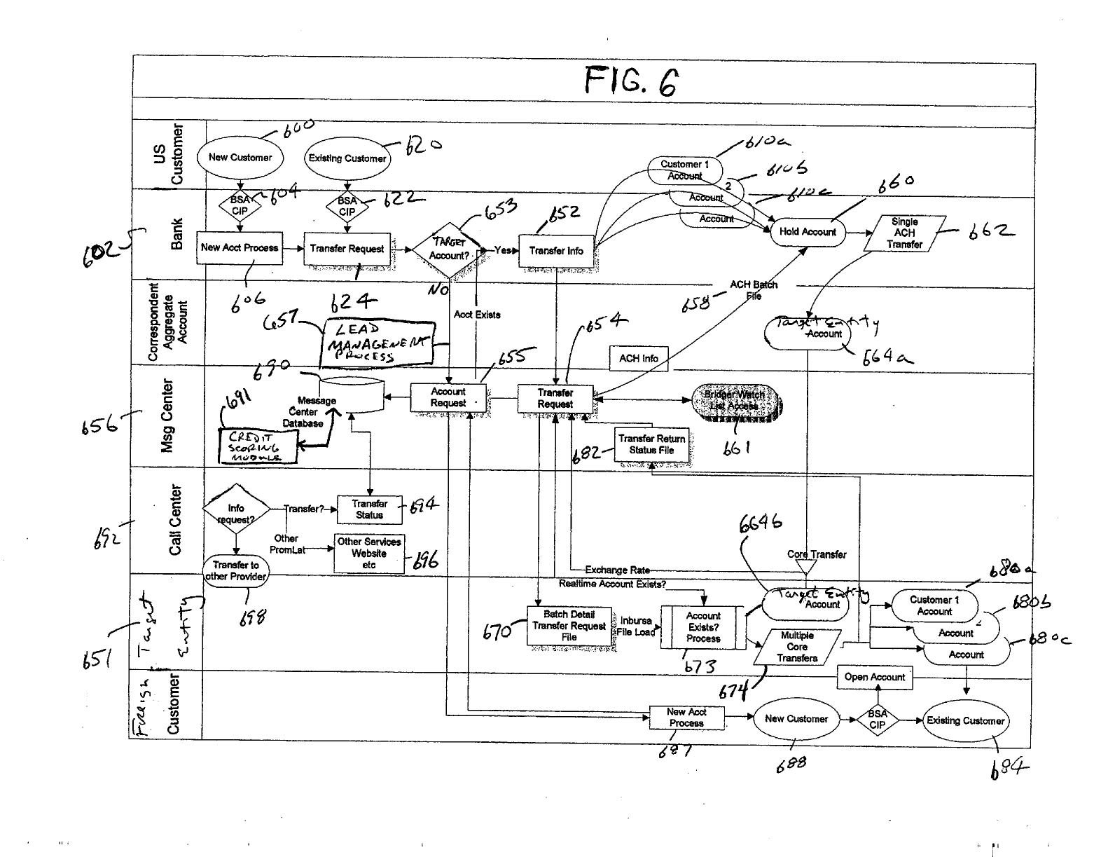

Referring now to FIG. 6, there is illustrated of a functional diagram of yet another example embodiment of the inventive subject matter hereof. Using the system of FIG. 6, a customer of a US bank, for example but not limited to a community bank, may initiate a transfer of funds to a target recipient, for example a relative or friend or business in another country such as, but not limited to Mexico, another Latin American country, an African country, an Asian country, or any other country. Alternatively, the “domestic” account may be in a country outside the US, and the foreign account an account foreign to the particular country of the domestic account. Thus, it shall be understood that in the example given below that the domestic country is the US, and the foreign countries are those other than the US.

Using the system of FIG. 6, the process for establishing a new customer begins with the new customer 600 contacting, for example in person or by phone, mail, Internet or other means, a bank 602, or other financial institution such as a credit union or brokerage firm. A customer identification is obtained, for example pursuant to a customer identification program (CIP) procedure 604 sufficient to meet regulatory requirements, such as those required by the United States Bank Secrecy Act (BSA). A new account process 606 is then performed, and is used to establish an account 610a (such as but not limited to a checking account or a savings account) with the bank 602. If the new customer 600 wishes to make a transfer request, to transfer funds from the account 610a, 610b or 610n, a transfer request 624 is made, as described below. Alternatively, a non-financial institution may host the account 610a, such as a credit card company or telephone company, as may be permitted by law, for instance.

If an existing customer wishes to make a transfer, the existing customer 620 is identified, for example with a procedure 622 pursuant to a customer identification program. A transfer request 624 may comprise, according to one example embodiment, a request to transfer funds from the customer account 610 to at least one target account 680a, 680b or 680n for one or more target recipients (typically one recipient has one account) who may access the funds in a country outside the United States. According to one example embodiment, target accounts 680 are maintained at a sponsor target entity 651, for example a foreign bank such as Inbursa, Groupo Financiero, with locations in Mexico. Alternatively, accounts 680a-n may be maintained by a target entity that is not a banking establishment, such as a telephone company. In any event, there is no necessity that the accounts 680a-680n be maintained by a bank or other financial institution. Prior to initiating a transfer, a query to verify the existence and possibly account identification information is generated at account query module 653 to an account request processing module 655 which in turn queries a message center database 690 that maintains records for all accounts held by possible target entities for target recipients. If no target account 680a-n exists or if an account identifier, such as an account number, of an existing account, such as a customer account 680a-n, is unknown for the target recipient as determined at 653, then a new account process is initiated via the lead management process 657 as explained below.

If a target account, such as target account 680a, currently exists, transfer information 652 is collected, for example into one or more files stored on a computer system, for example but not by limitation of, in a RAM memory or in a magnetic-based memory, or any other form of storage. The transfer information is sent to a transfer request processing module 654 maintained in, for example but not by way of limitation, a message center 656. Message center 656 may be a physical location, or it may be a virtual facility formed of one or more computer systems or software systems. In other embodiments, the message center 656 resides within a bank 602 participating with the system. Module 654 collects the transfer information 652 and forms an ACH batch file 658. ACH batch file 658 is processed by one or more banks or clearinghouses to move transferred funds from one or more customer accounts 610a, 610b, 610n, at one or more banks, to a hold account 660. In one embodiment, funds from a plurality of transfer requests (and corresponding debits of one or more customer accounts) are placed in the hold account 660 to form an aggregate amount. According to one embodiment, transfer requests are provided to a Bridger Watch List Access point 661 that may be accessed to monitor financial transactions.

In one embodiment, a single ACH transaction 662 is performed to transfer the aggregate amount from the hold account 660 to a target entity account 664a kept for the benefit of the sponsor target entity 651, for example in the United States. The ACH transaction 662 may be initiated by the message center, or by the target entity 651, or by the bank 602. A core transfer of the funds, such as an inter-company transfer, in the account 664a is made to another target entity account 664b, for example kept in the foreign country to which the funds are being transferred to the target recipient.

In association with the transfer of the aggregate amount into the target entity account 664, a batch detail transfer request file 670 is forwarded to the target entity 651. The target entity 651 loads the file into a computing system for the target entity 651. If the account exists 673 a process 674 performs a core transfer of funds from the account 664b to one or more customer accounts 680a, 680b, 680n, held by the target entity 651 for the benefit of target recipients. An exchange rate for the transfer of funds may be returned to the transfer request processing module 654 and if desired kept in a database 690. A transfer return status file 682 is also generated and forwarded to transfer request processing module 654, to provide confirmation of a successful transfer.

In the case of an existing target recipient, or customer 684, funds may be withdrawn once deposited in the target recipient' account 680. In the event that no account exists or if an account identifier, such as an account number, of an existing account, such as a customer account 680a-n, is unknown for the target recipient 684 as determined at 653, then an open the lead management process 657 is triggered. The lead management process 657 is operable to facilitate account setup to allow fund transfers from a customer, such as new customer 600 or existing customer 620, to either an existing customer 684 or a new customer 688. The lead management process 657 receives or obtains customer identification and contact information from either the new customer 600 or existing customer 620 about the new customer 688 or existing customer 684 that is to receive funds. The information can include name, address, postal code, telephone number, and any other information useful to identify or contact the customer to receive funds.

The lead management process then identifies a target entity 651 location in closest proximity to the customer to receive funds. Information about the identified closest target entity 651 location is provided to the new customer 600 or existing customer 620 that will provide funds to transfer. The customer to transfer funds then can provide the target entity 651 location information to the customer to receive funds. The lead management process 657 further forwards the customer identification and contact information of the customer to receive funds to the identified target entity 651 in closest proximity to the customer to receive funds. The target entity 651 can then contact the customer to receive funds.

The customer to receive funds, if an existing customer 684, can then contacts the call center 692 and provides their account number of the target entity 651 account that transferred funds will be deposited to. If the customer to receive funds is a new customer 688, the target entity 651 initiates a new account process 687, which in turn establishes a new customer account 680 using an open account process 690, using, for example, suitable identification 688 of the customer or target recipient. Confirmation of the opening of the account is sent to the account request processing module 655, which in turn updates the database 690. However, in some embodiments, the account number of the new customer account 680 is not provided. The new customer 688 must contact the call center 692 to provide the account number 680 of the target entity 651 account that transferred funds will be deposited to. Once the call center 692 receives a previously unknown account number from a customer to receive funds, the account number is stored in the message center database 690 and fund transfers from the customer to transfer funds to the customer to receive funds can be initiated and completed.

According to another example embodiment, a call center 692 is provided, and allows telephone access to the status of transfers 694, as may be pulled from database 690 either by a live operator or by using automated call processing technology such as dial tone recognition or voice recognition, or both. Alternatively, online access to transfer information may also be provided through a web site 696. In the event that calls are for other providers, the calls are transferred 698 to other providers.

According to another example embodiment, the operation of the fund transfers through the message center functions and the provision of call center services is provided in whole or in part by a party independent of the domestic and foreign target financial institution. In this embodiment, this independent third party may serve a number of domestic financial institutions and more than one foreign financial institution. For example, the third party may assist a domestic financial institution to advertise and promote a program allowing its customers to transfer funds to target recipients in a foreign county that have accounts with a target entity. Thus, in this embodiment, the third party provides a method for funds transfer not otherwise available to the domestic or foreign entities. In another embodiment, the domestic and foreign entities support the transfer operations, call centers and message center in whole or in part themselves alone or in combination.

In some embodiments, the account receiving fund transfers, such as a customer account 680, is tied to a remittance card. The remittance card can be a debit card, credit card, or other device useful to make payments. The remittance card can be used in place of currency. When presented, the customer account 680 tied to the remittance card can be used not only to make purchases, but also to obtain currency from an automated banking machine, such as an ATM, or from a money till at a store such as a gas station, department store, or virtually any other type of store maintaining a cash till, such as is maintained in a cash register.

In some such remittance card embodiments, more than one remittance card can be tied to a single customer account 680. For example, two or more cards have equal privileges to the access funds deposited in the customer account 680. In other embodiments, two or more cards are tied to a single customer account 680, but one or more of the cards have access to only a portion of the finds in the customer account 680. For example, a customer account 680 with two remittance cards tied to it has the equivalent of $1,000 US balance. Card A has access to $350 and Card B has access to $650. Each card is limited to access and utilizing only their respective portions of the total account balance. In other embodiments, each of two or more cards have limited access to funds in a customer account 680 based on an allotted percentage of funds deposited in the customer account.

In other embodiments, the customer account 680 can be debited directly by one or more merchants or service providers, such as a medical service or insurance provider. In some such embodiments, the customer account 680 is tied to a remittance card that operates as an instrument to receive medical services. In some instances, the remittance card operates as a guarantee, or insurance, that payment for rendered medical services will be made.

In some embodiments, the message center 656 further includes a credit scoring module 691. The credit scoring module 691 operates to generate a score based on historical data maintained in the message center database 690 of funds transferred via the system by an existing customer 620. A score generated by the credit scoring module 691 can be used by entities making credit granting decisions. In some embodiments, the credit score from the credit scoring module 691 can be added to an expansion score or other credit score such as a FICO score or a Fair Isaac score. The credit scoring module 691 generates scores based on business rules that derive a score from historical transfer and potential direct deposit data.

In some embodiments operated by certain sponsoring entities, such as a department store or gas station chain, customers transferring funds or receiving funds receive loyalty points for use of the system. For example, at certain fund increment amounts transferred or received via the system, a sponsoring entity grants a loyalty point. These loyalty point can then be accumulated as used to obtain special benefits such as prizes, money, merchandise discounts, and store credit.

All publications, patents, and patent documents are incorporated by reference herein, as though individually incorporated by reference. Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the invention. It is manifestly intended that this invention be limited only by the following claims and equivalents thereof.

What is claimed is:

1. A method of transferring money from a non-citizen resident of the United States to a recipient outside of the U.S. without the use of a bank in the recipient's country, comprising:
providing points of access to the non-citizen resident;
accessing pre-defined transfer policies of the non-citizen resident; and
initiating a transfer of funds according to the accessed policies.

2. The method of claim 1, wherein the points of access are small to medium sized banks.

3. The method of claim 1, wherein the points of access are community banks.

4. The method of claim 1, wherein the points of access are credit unions.

5. The method of claim 1, further comprising:
transferring funds according to the access policies to a recipient's cash-equivalent device.

6. The method of claim 5, wherein the cash equivalent device is a smart card.

7. The method of claim 5, wherein the cash equivalent device is a credit card.

8. The method of claim 5, wherein the cash equivalent device is a stored value card.

9. The method of claim 5, wherein the cash equivalent device is a token based device on which information about an account balance can be stored.

10. The method of claim 9, wherein the account balance is securely stored.

11. A method of providing a money transfer service to non-citizen residents, enabling the non-citizen resident to effect a monetary contribution to persons in a foreign country, the method comprising:
receiving a deposit of an amount of monies into a depository account at a source location banking institution;
accessing a pre-defined list of policies governing the allocation of the deposited monies;
communicating an Electronic Funds Transfer (EFT) request for the transfer of the allocated monies;
processing the EFT request;
transferring an amount of monies similar to the allocated monies to an institution in the recipient's country;
providing a method for the recipient to add the transferred money to a cash equivalent device; and
providing a call center for the facilitation of this transfer of monies, as well as for the reporting and resolution of issues with the transfer or receipt of the transferred monies.

12. The method of claim 11, wherein the source location banking institution is a small to medium sized bank.

13. The method of claim 11, wherein the source location banking institution is a community bank.

14. The method of claim 11, wherein the source location banking institution is a credit union.

15. The method of claim 11, wherein the institution in the recipient's country is a non-banking institution.

16. The method of claim 15, wherein the non-banking institution is a telephone company.

17. The method of claim 11. wherein the providing a method further comprises:
locating stations convenient to the recipient;
reading the cash equivalent device;
accessing information in regards to transferred monies;
adding a value equivalent to the transferred monies onto the cash equivalent device;
returning the cash equivalent device to the recipient.

18. The method of claim 11, wherein the call center is staffed with personnel fluent in the languages of the non-citizen resident, the recipient, the source location banking institution and the institution in the recipient's country.

19. The method of claim 11, wherein languages include the language of the EFT Service Provider.

20. A method of sending money from non-citizen residents to family members in a foreign country, comprising:
setting up an account at a member bank, wherein the account stores information as to intended recipients and allocation percentages;
receiving a deposit of monies;
depositing the deposit of monies into the account, transferring money using Electronic Funds Transfer (EFT) systems from the set-up account to recipient accounts,
accommodating current exchange rates between the sender's country and the recipients country;
providing terminal based systems where the recipient can access the transferred money;
debiting the non-citizen resident's account for the amount of the transfer and a transaction fee; and
providing call-center services for users of the system to resolve problems.

21. The method of claim 20, wherein depositing includes cash deposits made at a teller.

22. The method of claim 20, wherein depositing includes direct deposits made by the non-citizen resident's employer of a non-citizen resident's paycheck.

23. The method of claim 20, wherein depositing includes cash deposits made at an Automated Transfer Machine (ATM).

24. The method of claim 20, wherein depositing includes non-cash deposits made at a teller.

25. The method of claim 20, wherein depositing includes non-cash deposits made at an ATM.

26. The method of claim 20, wherein transferring money includes transferring monies according to the information stored in the non-citizen resident account.

27. The method of claim 20, wherein providing terminal based systems where the recipient can access the transferred money includes recharging a cash equivalent card at a public telephone terminal.

28. The method of claim 20, wherein providing call-center services for users of the system to resolve problems includes enabling dynamic changing of transfer policies.

29. A method of providing Electronic Funds Transfer (EFT) services to small banks in areas populated by large immigrant populations, comprising:
building relationships with institutions in the recipient's country;
providing marketing materials to the small banks as to the service;
providing a call center for the faciliation of the service and the resolution of problems with it;
training customer service representatives that are employees of the small bank as the service and the setting up accounts to use the service; and
providing a single point of entry for the EFT request.

30. A method of integrating a non-citizen resident into the banking user community:
providing easy to use money transfer services for the non-citizen resident to send money to family members in their country of origin;
facilitating the on-going period transfer of monies from the at least one of the non-citizen's accounts to cash equivalent devices;
providing customer service representatives that are fluent in the language of the non-citizen resident; and
providing other banking services to the non-citizen resident on an on-going basis.

31. A method comprising:
receiving a funds transfer request from a transferring customer to transfer funds to a receiving customer, wherein the funds transfer request is received by a transferring entity;
determining if the receiving customer has an account capable of receiving transferred funds;
placing funds to be transferred into a hold account if the receiving customer has an account capable of receiving transferred funds and placing a record into a batch detail transfer request file; and
transferring the funds in the hold account and the batch detail transfer request file to a target entity.

32. The method of claim 31, wherein the funds in the hold account and the batch transfer request file are transferred to the target entity via an intermediary.

33. The method of claim 32, wherein the intermediary is a message center.

34. The method of claim 31, further comprising:
sending identification and contact information of a customer to receive funds to a target entity in closest proximity to the customer to receive funds if the receiving customer does not an account capable of receiving transferred funds or if the account number is unknown to the transferring customer; and
receiving an account number of the receiving customer from a message center.

35. The method of claim 34, wherein the requested fund transfer proceeds upon receipt of the receiving customer's account number.

36. A method comprising:
processing fund transfer requests from a customer of a first entity to a customer of a second entity;
maintaining a database of processed fund transfer requests, wherein the database includes historical data of fund transfers processed for the customer of the first entity; and
deriving a credit score for the customer of the first entity from the historical data of fund transfers processed for the customer of the first entity.

37. The method of claim 36, further comprising:
receiving a request for the derived credit score; and
providing the derived credit score to the requester.

38. A method comprising:
creating and maintaining customer accounts to receive transferred funds;
receiving a single transfer of funds;
receiving a batch detail transfer request file; and
distributing the received single transfer of funds amongst the customer accounts according to data in the received batch detail transfer request file.

39. The method of claim 38, wherein an owner of a customer account can access funds from the owner's customer account using a remittance card issued to the owner of the customer account.
